(19) United States
(12) Patent Application Publication
(10) Pub. No.: US 2008/0299358 A1
(43) Pub. Date: Dec. 4, 2008

(54) Transparent Barrier Tape

(76) Inventor: David M. Kuchar, Metuchen, NJ (US)

Correspondence Address: STANLEY H. KREMEN, 4 LENAPE LANE, EAST BRUNSWICK, NJ, 08816, US

(21) Appl. No.: 11/755,098

(22) Filed: May 30, 2007

(51) Int. Cl. B32B 3/00

(52) U.S. Cl. 428/203

(57) ABSTRACT

A flexible barrier tape formed of transparent web material being substantially longer than it is wide and having indicia on one or both sides of the tape. When the tape is suspended in air, the indicia can be viewed from either side. The indicia can be applied to the tape as a single layer or as multiple layers. The effect produced by this barrier tape to an observer is that of the indicia floating in mid-air. This effect may be used to enhance the noticeability of the barrier or its message.

### CROSS REFERENCE TO RELATED APPLICATIONS

The present invention is related to my U.S. Pat. No. 5,244,715 (issued Sep. 14, 1993, and entitled FLAG STRIP), U.S. Pat. No. 6,929,843 (issued Aug. 16, 2005, and entitled FENCE TAPE), and U.S. Pat. No. 7,125,597 (issued Oct. 24, 2006, and entitled PENNANT TAPE). Said patents are incorporated in their entirety by reference herein.

### BACKGROUND OF THE INVENTION

### Field of the Invention

The present invention is an improvement over ribbons or strips used to mark off work or hazardous areas. More specifically the present invention provides for a more visible ribbon or strip type barrier.

### SUMMARY OF THE PRIOR ART

Tapes, ribbons or strips, usually of highly flexible resinous web material, are commonly used as barriers between elevated supports to prevent pedestrians or vehicles from entering hazardous or unauthorized areas. Often, the tape material is brightly colored, frequently yellow or orange, and may additionally have some sort of cautionary message printed on the tape in a contrasting color, such as black. For example, the word “CAUTION” is often repeated along the length of the ribbon. Thus, when the ribbon or tape serves as a barrier, its bright color allows it to be seen more readily, and the written message warns people not to enter the area beyond or to proceed cautiously. For this reason, it is vitally important that a barrier tape with maximum visibility be used to rapidly alert viewers in the area to potentially dangerous circumstances.

This traditional type of barrier tape or ribbon is very popular because it is easy to handle and can be tied between most permanent or temporary structures. These barrier tapes are unique from and not to be confused with adhesive tapes which serve a wholly different function for which the two are not interchangeable. Therefore, in the Present Application, barrier tape refers to tape made from a flexible web material that does not incorporate an adhesive thereon.

Barrier tapes are typically composed of brightly colored, non-transparent materials so as to more easily draw attention. There are examples of printing on transparent tape for purposes such as binding for packages or as underground structure indication by means of metal strips that are detectable above-ground, neither of which are conducive to acting as a barrier tape.

Cautionary messages printed onto traditional barrier tapes are sometimes viewed backwards by a person standing on the other side because the web material is not wholly opaque. This creates a need for a barrier tape that's readable from both sides so as to provide sufficient warning to viewers in the area, while at the same time maximizing visibility to act as the most effective possible warning.

### SUMMARY OF THE INVENTION

The Present Invention is a barrier tape comprising a transparent, flexible tape or ribbon and an applied message, symbol or combination thereof which is more readily perceptible than traditional, non-transparent barrier tapes. The use of transparent tape is counterintuitive in the construction of a barrier tape and, when combined with non-transparent printing, creates an unexpected result—the illusion of colors, symbols and/or cautionary messages seemingly floating in air. This draws additional attention to the barrier tape, thus reinforcing its purpose of alerting viewers as to its cautionary nature.

### BRIEF DESCRIPTION OF THE DRAWINGS

FIG. 1 shows the transparent flexible web material having a single layer of printing.

FIG. 1(a) is a cross-sectional view.

FIG. 1(b) is a view of the front face of the web material.

FIG. 1(c) is view of the reverse rear face of the web material.

FIG. 2 shows the transparent flexible web material having a single layer of printing.

FIG. 2(a) is a cross-sectional view.

FIG. 2(b) is a view of the front face of the web material.

FIG. 2(c) is view of the reverse face of the web material.

FIG. 3 shows the transparent flexible web material having two layers of printing.

FIG. 3(a) is a cross-sectional view.

FIG. 3(b) is a view of the front face of the web material.

FIG. 3(c) is view of the reverse face of the web material.

FIG. 4 shows the transparent flexible web material having three layers of printing.

FIG. 4(a) is a cross-sectional view.

FIG. 4(b) is a view of the front face of the web material.

FIG. 4(c) is view of the reverse face of the web material.

FIG. 5 shows the transparent flexible web material having two layers of printing on the front face and a single layer of printing on the reverse face.

FIG. 5(a) is a cross-sectional view.

FIG. 5(b) is a view of the front face of the web material.

FIG. 5(c) is view of the reverse face of the web material.

FIG. 6 shows the transparent flexible web material having different messages on opposite sides of the tape. FIGS. 6(a) and 6(b) represent the opposite faces.

FIG. 7 shows the transparent flexible web material having a single layer of printing.

FIG. 7(a) is a cross-sectional view.

FIG. 7(b) is a view of the front face of the web material.

FIG. 7(c) is view of the reverse face of the web material.

### DETAILED DESCRIPTION OF THE INVENTION

Barrier tapes, as known in the art, appear as brightly colored lines (or, according to the present Inventor's work, as disclosed and claimed in the patents incorporated herein by reference), as brightly colored lines adorned with flags. Heretofore it has been generally accepted that barrier tape can not, economically, be made more visible. Counter-intuitively, in its preferred embodiment, the barrier tape of the Present Invention, comprises graphic material printed onto a clear (i.e., colorless) transparent substrate.

No product currently exists that employs transparent material in the manufacture of flexible tape, ribbon or strip, used as a barrier tape in such a manner as to increase the visibility of the barrier by having opaque indicia on a background of transparent sections. Indicia, as used in the Present Application, refers to any visually observable markings. One skilled in the art would be familiar with techniques that would produce a message coherent to viewers on both sides, either by printing on both sides of the web or by using multiple layers of printing. With the multiple layer printing of the Present Invention, it is possible to have different messages on opposite sides of the barrier.

An observer of the deployed (suspended in air) transparent barrier tape sees printed material in one plane and, through the transparent portions of the tape, the scene in which the tape is deployed (elements of which may be moving). If the observer is moving (i.e., translating, rather then gesticulating), as one approaching the tape must be, the scene, visible through the transparent portions of the tape, moves relative to the printed material. This is true even when the approach is perpendicular to the plane of the tape, as the approaching observer sees the scene expanding (by ordinary rules of perspective). The scene elements, visible through the transparent portions of the tape, move outward from the line of approach. Thus, transparent barrier tape causes a highly animated, three-dimensional effect that, in many environments, is more noticeable than ordinary barrier tapes (or may enhance their effect, when used in tandem).

In addition, at an observation distance that depends largely on the spacing and size of printed and transparent areas and the distance and details of portions of the environment visible through transparent portions of the tape, the plane of the barrier may become momentarily ambiguous. The effect is particularly apparent with closely repeating simple patterns (such as the preferred hash-mark tape) and is caused by the observer's eyes converging on an element of the background, each eye through a different transparent portion of the tape. This effect is startling to the approaching observer, which further enhances the ability of the tape to slow the approach.

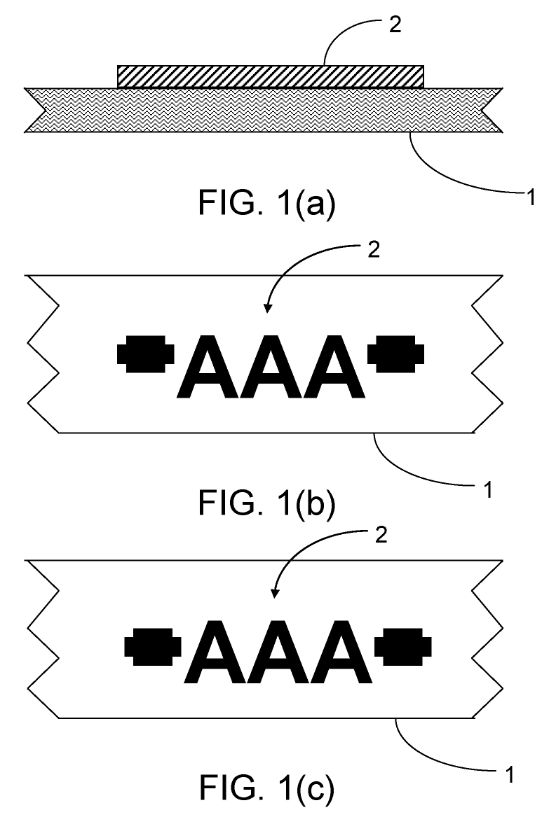

Referring to FIG. 1, a section of tape 1 is shown with a single layer of printing 2 in the form of a symmetrical indicia that is viewed the same from either side of the tape. A viewer would be able to easily distinguish the indicia from either side, thus effectively conveying the message of the barrier tape.

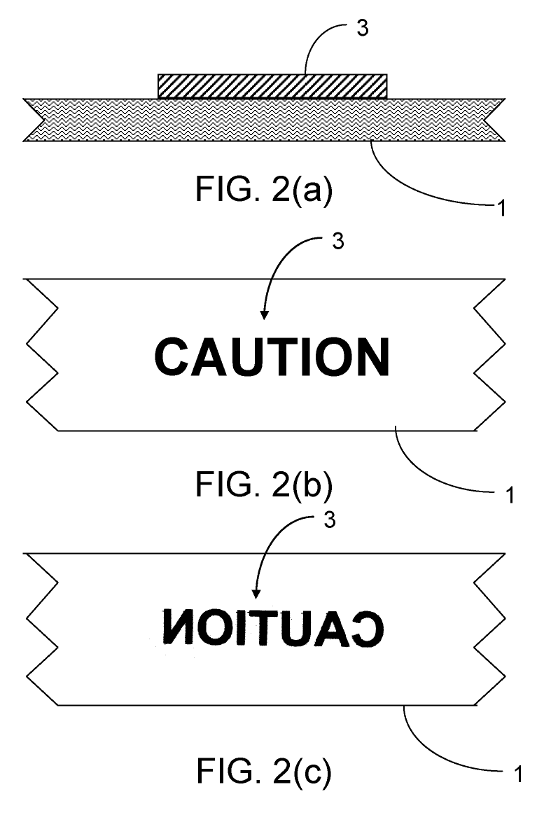

Referring to FIG. 2, a section of tape is shown with a single layer of printing 2 in the form of non-symmetrical indicia, the word, “CAUTION.” When viewed from one side, it would be correctly oriented to the viewer and easily understood. From the other side, however, it would be read in reverse, which is incomprehensible to the reader. Traditional barrier tapes are not completely opaque, and therefore may display messages in this manner.

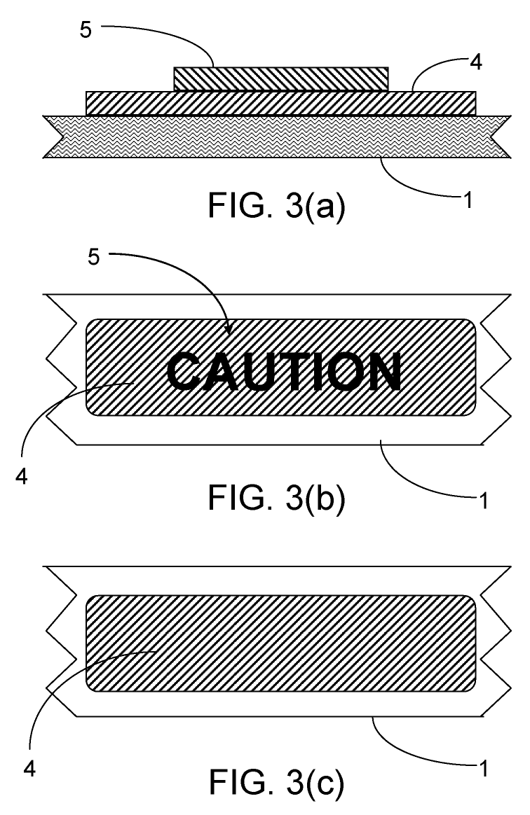

FIG. 3 shows a section of tape 1 with two layers of printed indicia 4, 5 printed in such a manner that the bottom layer of printed indicia 4 is closest to the tape and acts as a contrasting background for the top layer of printing 5 to further increase visibility of the printed indicia. When viewed from the side with the printing on it, both layers of printing would be visible and effectively convey the purpose of the barrier tape. When viewed from the opposite side, only the background layer 4 would be visible.

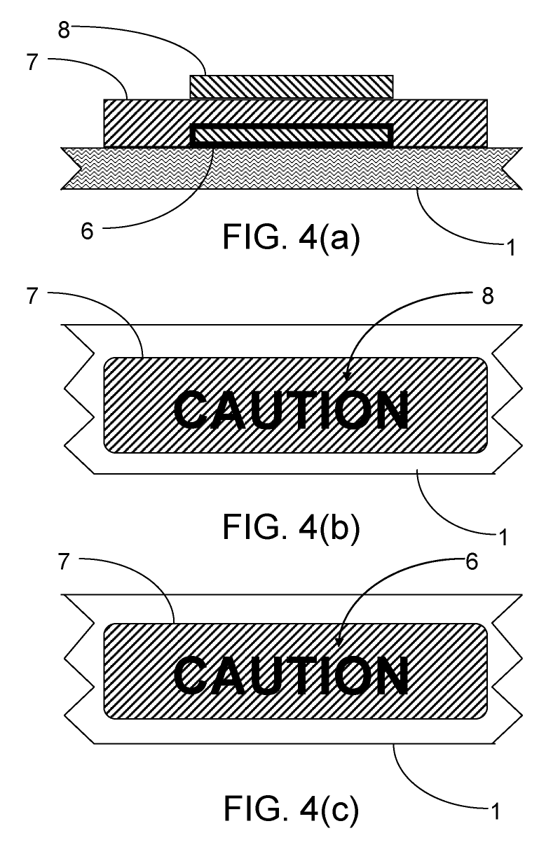

FIG. 4 shows a section of tape 1 with three layers of printed indicia 6, 7, 8 printed in such a manner that the bottom layer of printing 6 is closest to the tape and would be visible through the transparent tape 1. The middle layer of printing 7 would act as a contrasting background to both the bottom layer of printing 6 and the top layer of printing 8. The top and bottom printed layers 6, 8 are each of indicia correctly oriented to the viewer on the respective sides of the tape, thus allowing the barrier tape's message to be clearly viewable from both sides and easily understood by all in the nearby area.

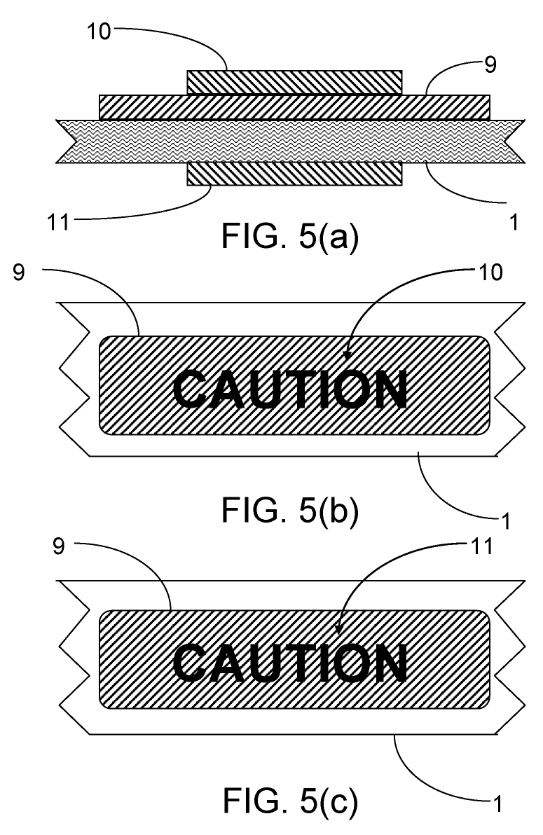

FIG. 5 shows a section of tape 1 with two layers of printed indicia 9, 10 on the top side of the tape 1 and a second single layer of printed indicia 11 on the bottom side of the tape 1. Similar to FIG. 4, the bottom printed layer 9 of indicia on the top side acts as a contrasting background to the top printed layer 10 on the top side of the tape and to the single printed layer 11 on the bottom side of the tape. Both the top printed layer on the top side 10 and the single printed layer on the bottom side 11 of the tape 1 are correctly oriented to the viewer on their respective sides to allow the message on the tape 1 to be clearly visible.

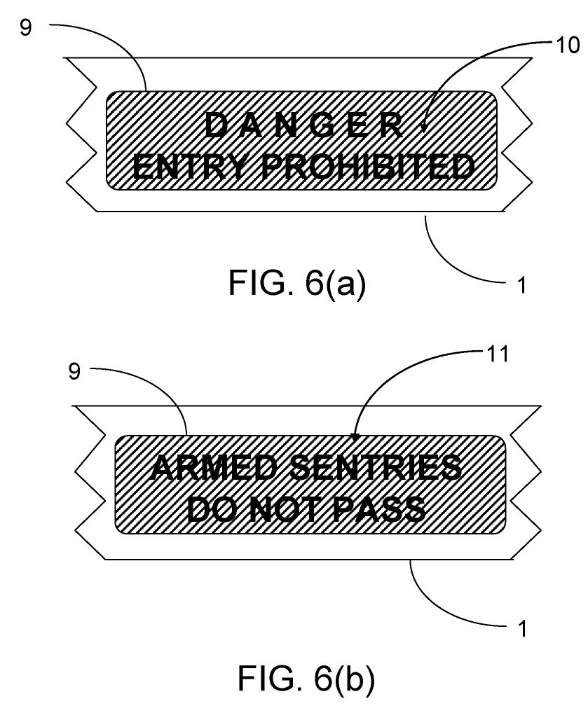

FIGS. 3, 4, and 5 illustrate the condition where the indicia or message visible from one side of the barrier tape may be different from the indicia or message visible from the other side of the tape. This can be very useful in many different situations where instructions or commands provided to observers situated on either side of the tape must be different. For example, in a lo quarantine situation, persons on one side of the barrier (refer to FIG. 6(a)) might see a message that states: “DANGER—ENTRY PROHIBITED.” However, persons on the other side (refer to FIG. 6(b)) might see a message stating: “ARMED SENTRIES—DO NOT PASS.”

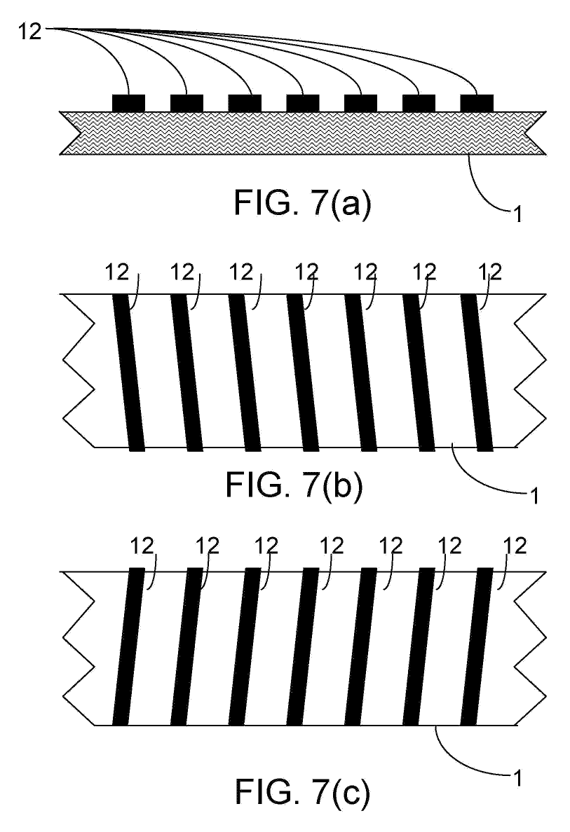

FIG. 7 shows a section of tape 1 with a single layer of printed indicia 12 in a hatch pattern. The hatch pattern is equally visible from either side of the tape with no apparent loss of significance due to reversed orientation of the hatching as seen on the opposite side from the printed indicia 12.

1. A flexible barrier tape formed of transparent non-adhesive web material having two faces, said tape being substantially longer than it is wide and comprising indicia thereon, wherein the tape is suspended in air, and wherein the indicia encompasses an area that is smaller than the entire area of the tape.

2. The tape of claim 1 wherein the web material is essentially colorless.

3. The tape of claim 1 wherein the indicia is applied to one face.

4. The tape of claim 1 wherein the indicia is applied to both faces.

5. The tape of claim 1 wherein at least a portion of the indicia is opaque.

6. The tape of claim 1 wherein the indicia is discontinuous.

7. The tape of claim 1 wherein the indicia is applied as more than one layer on either face or both faces.

8. A flexible barrier tape formed of transparent non-adhesive web material having two faces, said tape being substantially longer than it is wide and comprising indicia thereon wherein the tape is suspended in air such that it can be viewed from either face, and wherein the indicia viewable from one face is different from the indicia viewable from the other face.

9. The tape of claim 8 wherein the web material is essentially colorless.

10. A flexible barrier tape formed of transparent non-adhesive web material having two faces said tape being substantially longer than it is wide, and suspended in air, and comprising indicia thereon alternating with transparent regions.

11. The tape of claim 10 wherein the web material is essentially colorless.
